(19) United States
(12) Patent Application Publication
(10) Pub. No.: US 2005/0276890 A1
(43) Pub. Date: Dec. 15, 2005

(54) Method of and apparatus for processing continuous discrete batches of particulate product

(75) Inventors: Jon F. Baker, Sidney, OH (US); Sandra M. Schulze, Yorkshire, OH (US)

Correspondence Address: WILLIAM WEIGL, 1805 Conwood Dr., Troy, OH, 45373, US

(73) Assignee: SIDNEY MANUFACTURING, INC.

(21) Appl. No.: 10/866,051

(22) Filed: Jun. 14, 2004

(51) Int. Cl. C12H 1/10

(52) U.S. Cl. 426/333

(57) ABSTRACT

A trough-type watertight drag conveyor for particulate material to be processed commences initial stages of the processing while the material is still within the trough. More specifically, in one significant application of the invention, treating liquid is utilized during the processing, this liquid serving further to assist in the conveyance and thereby minimize potential damage to certain materials. Paddles dragged along the trough essentially dam the material in relatively discrete batches. Despite being isolated in batches, the product flow is continuous, the batches being separated only by the thickness of the paddles. Conveyor speed is controlled to allow sufficient residence time of the material within the treating liquid in those instances where required. The paddles are restrained against lifting from the trough bottom to maintain a fairly intimate seal between the trough and paddles. The treating liquid is extracted from the material prior to discharge from the conveyor, and in its preferred form, the treating liquid is recirculated and reused.

This invention relates to drag conveyors for particulate material to be processed, in which a portion of the processing is conducted while the material is still being transported within the drag conveyor trough. In one preferred form, it relates to a system in which the processing includes liquid treatment of a product, and in which the initial part of the processing comprises soaking of the material for a predetermined time period. The soaking is then followed by a rapid and essentially complete extraction of the soaking liquid while the material is still within the drag conveyor.

### BACKGROUND OF THE INVENTION

It is well known in the particulate food industry involving canning, that where some product pre-treatment is required, it can often be done during conveyance. One example is the dicing of tomatoes, belt-conveying the “diced” toward and through a tank of water and calcium chloride, raising the product out of the liquid by means of the belt, and delivering the treated tomatoes to another conveyor which takes them toward cooking and canning stations. The belt used in this instance includes integral upstanding pusher flights perhaps a few inches in height, and the tank is stationary. The belt dips into the tank, continues for a distance intended to provide a predetermined soak time to the diced and is then inclined upwardly out of the tank. One problem affecting the end quality of the canned product is that eddy currents formed by the travelling belt can cause tumbling movement of the product backward of and around the flights within the tank, altering the desired residence time of diced in the liquid. On occasion, if the diced is piled too high on the belt (above the liquid level) or if the liquid level is not maintained, the upper layer of diced on the belt may not receive any or only slight immersion. This is detrimental to desired preservation quality of the end product. Along with this, there may be about a 1% to 5% loss of product, juice and soak liquid from the tank and the belt during the conveying and transfer to take-away equipment. Ideally, treated diced is firm after conveyance, and is given a hardness test. If the intended soak time is not accomplished, or if the diced tends to be too soft as a result of tumbling while being conveyed, an inferior product may result. One canning plant in California utilizing a belt soak conveyor of the above type handles about 40,000 semi-trailer loads of tomatoes during a three month harvest period, simply for the preparation and canning of diced tomatoes. A loss of only one percent of that amount of product is huge, averaging out to four-and-one-half truckloads per day out of a total of four hundred fifty. Of the remainder that is successfully canned, the preservation and appearance quality, though generally acceptable for consumer purposes, can stand improvement.

Another type of conveyor used to a lesser extent for this particular application is an upwardly-inclined augur screw in which flights push the diced through a tube that is partially immersed in liquid. Product loss is avoided in this conveyor approach because the diced is contained within the tube. The augur must inherently slide against the diced product as it pushed it along, creating the potential for a less-firm end product, depending on the conveyor speed. Whatever the reason, these conveyors appear to have less acceptability in this industry than belt conveyors. Both types have throughput limitations, since any increase in speed will result in greater liquid churning, attendant product damage and reduced control of product residence time in liquid.

The question has remained until now as to whether other types of conveyors can be made to overcome the limitations of those that have been in use for some time for this type of application. For example, drag conveyors have been known for well over a hundred years for conveying dry particulate or granular materials such as food grain, pelletized dogfood, plastics, animal feeds, powders, flour, coffee beans, fertilizer and the like from one location to another in manufacturing processes such as bagging, mixing, blending, pelletizing, etc. Why they have not been considered previously for soaking cut vegetables or fruits can be discerned from examining the structures and internal moving parts inherent in the designs of these long-available drag conveyors.

The art relating to drag conveyors for the above uses has changed very little during the 1900's, the most innovative drag conveyor being one that is illustrated in U.S. Reissue Pat. No. RE37,472 E granted to Jon F. Baker on Dec. 18, 2001. Another well-known drag conveyor is that of U.S. Pat. No. 5,174,433 granted on Dec. 29, 1992 to Robert H. Moser. Both claim self-cleaning capabilities. The term “self-cleaning” as it relates to the drag conveyor art indicates that upon completion of conveying one product, the machine can be kept running for a short time period to remove all of the particulate from the trough. The troughs are designed so that gravity directs all product toward the very bottom of the trough, which is intended to be scraped clean. This avoids contamination between different products when at changeover.

To the best of our knowledge, drag conveyors have not been used previously for products that are “wet”, i.e., a product that is immersed in water or other liquid as contrasted to one that is slightly moist. For a good many years, they appear to have been used almost completely with the “dry” products noted above. Some of these machines are in excess of a hundred feet in length, rendering their cleaning at the end of a particular job a near impracticality if not self-cleaning. Many are used for a single product, avoiding contamination between products, while others are used in applications where contamination is of little or no concern. Thus, where the conveyors are used for handling different multiple products, and where avoidance of product contamination is essential, self-cleanability of the machine is an important desired feature. With the exception of the above Baker patent and a few machines similar to the Moser design noted earlier, most drag conveyors have numerous chain-supporting return idler sprockets within the trough and liquid-pervious shaft bearings for those sprockets along the trough. These sprockets can present obstacles to product flow, cause product damage, increase the potential for product contamination, and as now discovered, their bearings present a near impossibility of making the trough watertight for applications of the drag conveyors to “wet” conditions.

### SUMMARY OF THE INVENTION

A trough-type watertight drag conveyor for particulate material to be processed commences initial stages of the processing while the material is still within the trough. More specifically, in one significant application of the invention, treating liquid is utilized during the processing, this liquid serving further to assist in the conveyance and thereby minimize potential damage to certain materials. Paddles dragged along the trough essentially dam the material in relatively discrete batches. Despite being isolated in batches, the product flow is continuous, the batches being separated only by the thickness of the paddles. Conveyor speed is controlled to allow sufficient residence time of the material within the treating liquid in those instances where required. The paddles are restrained against lifting from the trough bottom to maintain a fairly intimate seal between the trough and paddles. The treating liquid is extracted from the material prior to discharge from the conveyor, and in its preferred form, the treating liquid is recirculated for reuse.

It is a principal object of the invention to commence treatment or processing of a particulate material while it is contained in a trough of a drag conveyor, particularly where the material is conveyed in a liquid and wherein the liquid is extracted from the material prior to completion of the conveyance.

A further object is to provide a type of conveyor for the purposes noted, where productivity can be greatly increased by lengthening a trough and increasing conveying speed while still achieving a required predetermined residence time of product in liquid.

Another object is to extract liquid from a material being dragged along a conveyor trough and recirculate the liquid for reintroduction into the trough for reuse.

A further object is to drag a particulate food material and liquid in continuous discrete batches between adjacent paddles of the drag conveyor, with the paddles damming and thus isolating one batch and its liquid from another and providing a predetermined residence time of the material in the liquid.

An ancillary object is to maintain the paddles in relatively intimate sealing and self-cleaning contact with the trough bottom and top surface of a drain screen by resisting any tendency of product to lift the paddles.

Another object is to provide for repetitive cleaning of the drain screen as each paddle passes thereover, thus maintaining the screen free of any tendency toward plugging.

A further object is to control the rate of speed of the paddles to provide a predetermined residence time of material in liquid.

Yet another object is to provide controlled discrete batches of liquid and product that are separated only by the thickness of the paddles, thereby providing high productivity while insuring an exacting and thorough residence time of all particulate material in its liquid.

Another object is to extract liquid from a product/liquid material at a location that is intermediate the inlet and outlet ends of the conveyor.

Still another object is to provide in a watertight drag conveyor a spraying system that, in conjunction with the self-cleaning aspects of the paddle design, achieve a complete and thorough automatic washdown of the trough by running the machine and spraying a wash liquid in an all-encompassing spherical pattern.

Other objects and advantages will become apparent for the following description in which reference is made to the accompanying drawings.

### DESCRIPTION OF THE DRAWINGS

FIG. 1 is a simplified schematic side elevational view of one form of continuous batch drag conveyor for performing the method of our invention.

FIG. 2 illustrates a vertical cross section of a preferred drag conveyor illustrating in section A what the depth of liquid might be if particulate material were not present, and section B showing both liquid and material at normal feeding depth.

FIG. 3 is a fragmentary enlarged pictorial sectional view of a preferred conventional screen for extracting liquid from the processed material.

FIG. 4 is a simplified vertical cross-sectional view similar to that of FIG. 2 but on a smaller scale, illustrating the self-cleaning capability of the conveyor and a wash system incorporated therewith.

### DESCRIPTION OF A PREFERRED EMBODIMENT

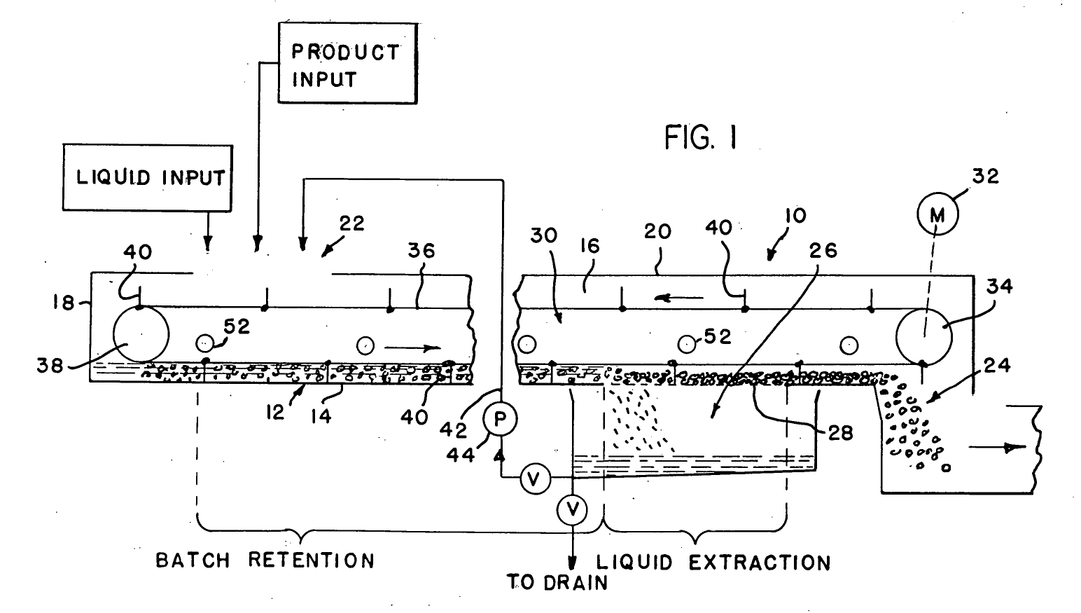

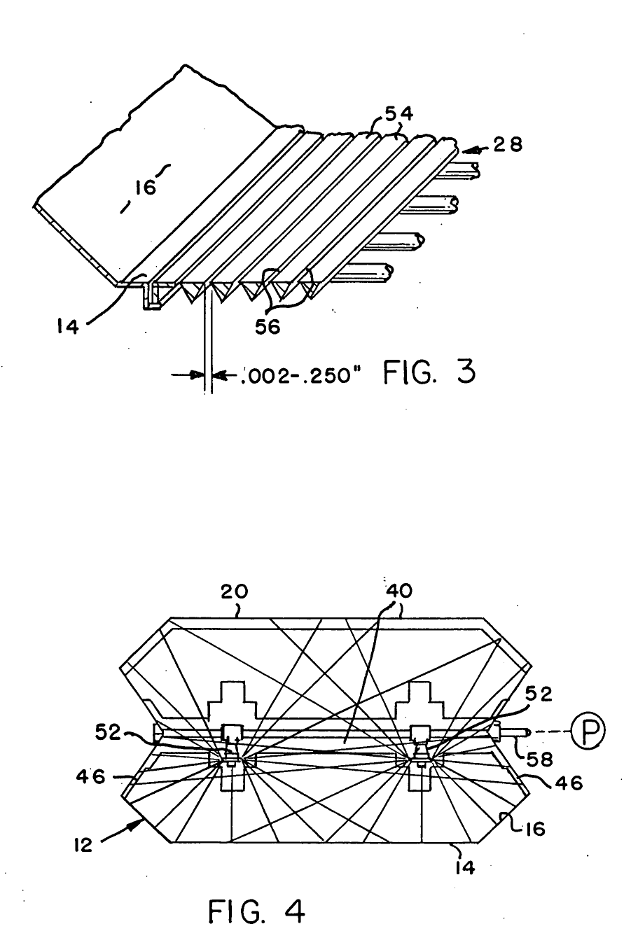

FIG. 1 depicts a schematic side view of a drag conveyor 10 with a trough 12 having a bottom wall 14, opposed side walls 16, an end wall 18 and a cover 20 extending for the length of the conveyor. Product and liquid is introduced in controlled fashion into the trough 12 at an inlet end 22 and product exits from the trough at an outlet or discharge end 24 from which it is taken away to other processing machinery by conveyors (not shown). Intermediate the inlet and outlet ends there is a liquid extraction section 26 that includes a drain screen 28, one form of which is shown in detail in FIG. 3.

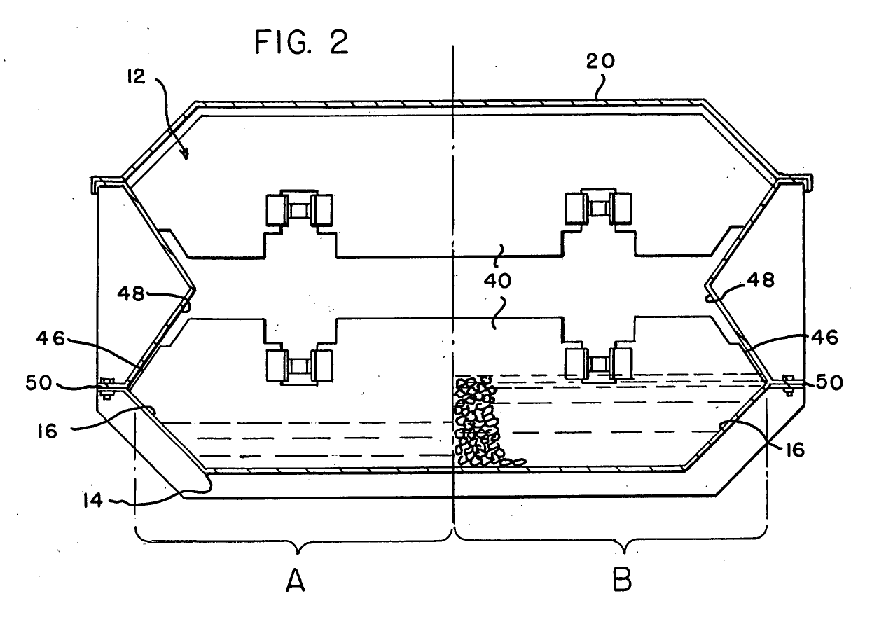

A continuous chain conveyor 30 is driven at what is commonly called the head end of the conveyor 10 by a motor 32 connected in common fashion to a drive sprocket 34. A chain 36 passes around the drive sprocket 34 and a driven sprocket 38 located adjacent the inlet end of the conveyor. A series of plastic paddles 40 extend radially outwardly from the chain 36 and extend laterally of the trough 12. As will be seen in FIGS. 2 and 4, the width of the conveyor, which may be as much as fifty inches, requires that the conveyor be provided with a pair of laterally-spaced chains 36 and their associated sprockets. The paddles 40 straddle the two chains and the chains are kept in the same tension to track the paddles through the trough at right angles thereto. Paddles 40 are typically spaced about twenty inches apart whenever the trough 12 is horizontal. They are located about ten inches apart if the trough has an upwardly inclined section because of the tendency of the product to settle back against the paddles on the incline due to gravity

In the system illustrated in FIG. 1, the liquid and product input are shown above the inlet end 22 for simplicity purposes, but in actuality the liquid is preferably introduced from each side essentially horizontally and product would be introduced from a conveyor located above and in line with the trough 12. Ordinarily, in one application of the invention that will be described, diced tomatoes will be fed from dicing machines onto the conveyor which is part of the previously-described product input. The “diced” will combine with a liquid, which in this instance is water and a controlled percentage of calcium chloride preservative. The combination is shown at the left end of FIG. 1 as particles in liquid. Once combined, they are maintained in what can best be described as quiescent, discrete batches, separated from one another only by the thickness of the paddles 40. The diced particles tend to ride upon themselves and move en masse in what could be described as a solid batch. Each batch contains liquid right to its top from the inlet end 22 to the liquid extraction section 26. The paddles are approximately one-half inch in thickness, thus, the batches are so close together as to enable the product to be described as a continuous flow. The significance of the separation of the product and its specific volume of liquid into discrete batches is that the residence time of the product in liquid must be kept near constant for all batches, providing uniformity of the end product in terms of firmness and preservation quality. All diced in said batch has liquid in the interstices between product particles and thus results in uniform soaking. The water and tomatoes are controlled to be introduced together to the depth of the paddles 40 just below the chains 36. Sufficient liquid in each batch must reach to the very top to produce the necessary uniformity. Dicing is typically sized between ½ and ¾ inches. The paddles have outer and side edges in contact with the bottom wall 14 and side walls 16 in what, for purposes of this invention can be described as essentially intimate contact. The machine embodying this invention is explained in detail in U.S. Reissue Pat. No. RE37,472 E granted to Jon F. Baker on Dec. 18, 2001, and is fully incorporated herein as part of this description.

When the discrete batches finish their travel from the inlet end to the liquid extraction section 26, the liquid is rapidly extracted, and in this particular application is recirculated through conduit 42 to the inlet end 22 either by gravity or pumped by a pump 44. In some instances for other applications, the liquid could be collected in liquid extraction section 26 and directed either to drain or to be collected elsewhere for salvage or reuse. Following extraction, the diced continue to be dragged over the drain screen and discharged at outlet end 24.

Once the desired capacity and residence time of the product in liquid is determined, known factors such as the length of the trough, the liquid flow rate, the speed of the paddles, chain and motor and the necessary controls are all designed into the machine.

A surprising aspect of the invention resides in the several failed attempts, and wasted time and dollars before the desired end goals were achieved. It was initially thought that the liquid level in the entire trough had to be uniformly maintained to achieve effective soaking. To accommodate this, the paddles were provided with perforations therethrough so that water could migrate between batches as it sought its own level. This proved to be ineffective, since the dice would plug the perforations. Also, the first attempted design included what is referred to in the drag conveyor field as a “bend section” at the end of the horizontal section of the trough, and to place the drain screen in the upwardly inclined portion of the bend section. For reference, and also incorporated herein is the disclosure of U.S. Pat. No. 6,142,291 issued to Sandra M. Schulze on Nov. 7, 2000. In FIG. 4 of the patent there is illustrated both a horizontal trough and a bend section inclined upwardly at forty-five degrees. It was in the initial attempt to solve the problem of the inadequate belt conveyor that a machine was built and tested for diced tomatoes with the liquid extraction section on the incline. When tested in house, it was found to be unacceptable because of all the water churning and backward tumbling and spillage of the diced and liquid over the top edges of the paddles as they went up the incline. This resulted in product damage rather than achieving the firm diced desired. (While this bend section drain design would not suffice for products such as diced tomatoes, it may very well be suitable for products such as baby carrots, where tumbling and churning is not detrimental to the process. To that extent it is considered within the scope of certain of the claims. But of necessity, the maximum volume of material and liquid in each batch would be dictated by the volume that can be contained forward of a pushing paddle as it moves up the incline.)

After rethinking the program, especially after noting that the paddle drain holes were plugging with product, the liquid extraction section was relocated to the horizontal trough, with the top surface of the drain screen 28 being made coplanar with the trough bottom wall 14. It was also learned that by coordinating the liquid flow into the trough with the chain speed, the desired liquid level was achieved. We still expected liquid to feed gravitationally around and under the paddles toward the drain, but to a lesser extent because the paddles with the perforations had been replaced. To our pleasant surprise, the liquid did not run out through the diced to drain as we expected, but was kept dammed up between adjacent paddles until a portion of it got directly over the liquid extraction section 26. By the time a batch passes completely over section 26, about 99% of the liquid has been removed. While there is still very slight seepage of water potential around the paddle edges, the liquid and diced remains at full depth and relatively quiescent, intact and in dammed condition between paddles. The containment of dammed water between paddles is sufficiently thorough to permit liquid to be fed by itself if desired for any reason. In fact, that is precisely how the machine has been demonstrated at trade shows, i.e., merely dragging and recirculating batches of water without particulate material. While a small amount of “leak-by” around the paddles can occur, by running the conveyor at a speed greater than the leak-by rate, the leak-by is insignificant. The machine involved is as described in the aforementioned Baker patent, i.e., it is self-cleaning as noted in the Background. It is entirely possible that there is more to what makes the system work as effectively as it does with a product such as diced tomatoes than might appear to an observer. It might possibly involve capillary action and adhesion between a product that has a high liquid content and the liquid itself. We also think an important reason for the feasibility of achieving the discrete batches and desired residence time of product in liquid is that the paddles are “captive”, i.e., they are maintained down toward the bottom of the trough. It is known in the drag conveyor industry that the higher the moisture content of a product, the greater is the tendency of the paddles to lift up from the bottom wall of the trough. The Baker patent describes the configuration of the trough of FIG. 2, and in particular with respect to this invention, the slight clearance 46 of about ¼th of an inch between portions of the paddles that coincide with sections of upwardly and inwardly inclined portions 48 of the side walls 16. Any tendency of the paddles to lift away from the bottom wall 14, a very common occurrence in drag conveying, is resisted by the fact that the slight clearance 46 closes rapidly and maintains the lower edges of the paddles against bottom wall 16 and side walls 16. While there might appear to be room for leakage at the clearances 46, this does not seem to be happening, possibly because the diced tomatoes particles may in fact act as plugs wherever there is leakage potential.

The paddles 40, as noted in the aforementioned Baker patent, are preferably made of ultra-high molecular weight nylon, polyurethane or similar material. The trough 12, chains 36 and bolts are made of #304 stainless, and joints 50 are made watertight with a silicone sealing material. The chain and paddle speed is between 10 and 20 FPM, depending on the required “residence time”. This can be compared to speeds of from 50 to 150 FPM for standard drag conveyors. The 10-20 FPM slow speed was also a cause for concern about liquid going direct to drain if it were to be extracted in a horizontal part of the trough. It will be noted that for simplicity of illustration in FIG. 2, the trough 12 is shown on the left side at A with liquid at the level it would be if there were no product in the trough. However, with product also present in the trough, the level of the combined liquid and diced would be at the level depicted by the bracketed portion B.

Referring back to FIG. 1, a plurality of spray balls 52 are located in various positions for the length of the trough 12, preferably about five feet apart. These will be described in greater detail in connection with FIG. 4. Suffice it to say for the moment that they serve at the end of a job to wash the insides of the trough much like a dishwasher, with spray impinging in all directions on all inner parts of the trough, the chains and sprockets. This spray while the machine is running, combines with the self-cleaning aspects of the paddles removing every bit of product at clean-up time, and is often referred to as C.I.P. for clean-in-place. A drag conveyor that is not self-cleaning is incapable of achieving C.I.P. Obviously, the tank type belt conveying system mentioned in the Background requires hand cleaning and hosing attention. It is estimated that in the California tomato processing plant mentioned earlier, there is one work shift of cleanup for each two shifts of production. Clearly, with the trough-type drag conveyor disclosed, product cannot escape during processing and cleanup within and around the machine is kept minimal. While C. I. P. is desirable in the industry discussed, it is not essential.

FIG. 3 shows very schematically a preferred form of the drain screen 28. It is made by Johnson Screens of 961 Abingdon Street, Galesburg, Ill. 61401 and is called Tri-Rod welded wire screen by its manufacturer. Triangular rods 54 are formed into a gridwork with a surrounding frame that sets into the bottom wall 14. The top surfaces of the rods 54 are coplanar or flush with the bottom wall 14 so that the paddles 40 move cleanly and without obstruction over the screen 28. Slits 56 between the rods of about 0.02-0.250 inches in width become the drain openings through which the liquid will flow by gravity into a tank forming a part of the liquid extraction section 26. The length and width of the drain screen 28 and the number of separate sections that may make up the total screen are determined by the amount of liquid to be extracted, the size of the particulate being processed and the speed of the chain and paddles. The drain screens are designed to be easily removable for cleaning and changing. Multiple sets of screens are typically provided with each machine. When a processing job is complete and the machine is to be cleaned in place, the screens 28 may be removed at the outset, and the spray balls 52 activated while the chains and paddles move through the trough.

Referring now to cleanup, a pressurized water line 58 extends crosswise through the trough 12 at approximately mid-point in its height. The line internally of the trough is fixed in place and has one spray ball directly over each chain 36. The spray ball is manufactured by Spray Systems Co. of Wheaton, Ill. and is referred to in their catalog as Fluid-Driven Tank Washing Nozzles w/360 degree pattern. It comprises a downwardly-depending tubular body about which a wash ring rotates when the tube is under pressure to its outer tubular surface. The ring has numerous angled jets that direct water under force is a near-spherical pattern to cause jets to contact the inner surfaces of the trough 12 from all angles. The effect is similar to that of the wash arm in a conventional home dishwasher. At the same time, the jets impinge on the chain and sprockets, also cleaning them while running. Any particulate material that remains in the trough 12 at cleanup time is eventually scraped and flushed either into the liquid extraction opening if the screens are removed, or the discharge end 24. If need be, the covers 20 may be removed in sections if any particular area of the trough must be accessed for hand cleaning.

While I have described the process and machine in connection with one application of treating diced tomatoes with calcium chloride in water, it is also used for residence time treating of baby carrots with plain water. As sold in sealed plastic bags, such carrots must have been treated with a predetermined residence time in water in order to have the proper moisture content for a long shelf life. With inadequate water soak time, carrots can tend to turn slightly white at their outer surface. While this does not affect their quality, it has consumer resistance. This reduces shelf life and may force retailer to sell the product at a discounted price. Unlike diced tomatoes, carrot firmness enables liquid extraction to take place on an incline. To accommodate backward potential of tumbling while rising, the paddles can be made higher than when used in a horizontal environment. This is shown by the portion of the paddles of FIG. 2 above the clearance 46. As noted earlier, where a product is one that is not adversely affected by liquid churning, draining on the incline is feasible, provided the volume of liquid and product is reduced to the capacity of water alone while on the incline. This is necessary to prevent liquid spillover backward of the paddles as they move up the incline.

Additionally, other still unexplored uses of the system and process are potentially available, and to the extent that the claims are of a breadth encompassing other apparent uses, we contemplate this to be within the scope of our invention. For example, the apparatus of FIG. 1 may be used for grape crush where it still contains some wine but must be conveyed to a squeezer or presser. Using our apparatus, additional juice or wine can be extracted at the liquid extraction section 26 and salvaged as usable product. Although “residence time” is not a consideration in this process, the apparatus may clearly be used for this purpose. Other similar uses of the apparatus are available where a combined liquid and particulate product must or should have the liquid removed before the final processing.

In some instances, the disclosed and claimed apparatus may be used primarily as a transporter, without product treatment. One example is where a large volume of water is used to carry whole tomatoes in the trough from one location to another, extracting the transporting water at the end and recirculating it as a conservation measure.

Various other changes may be made without departing from the spirit and scope of our invention.

1. The method of conveying a particulate product immersed in treating liquid and extracting the liquid from the product during the conveyance, comprising the steps of:
a. providing an elongated horizontal stationary watertight trough having a product and liquid inlet end, a product discharge end remote from the inlet end and a liquid extraction section intermediate said inlet and discharge ends, said trough having a bottom wall and opposing upwardly and outwardly-extending side walls for the length thereof;
b. providing an articulated continuous conveyor within the trough, which conveyor has a lower-run horizontal drag portion having relatively thin flat product-conveying paddles in contact with said product and liquid and an upper return run portion above said product and liquid;
c. said paddles being spaced apart along the conveyor and projecting radially outward and laterally thereof, and said paddles further having outer edges thereof closely conforming to the shape and size of the bottom and side wall configuration of said trough whereas to be in essentially intimate contact with the trough bottom and at least upwardly-extending portions of said side walls at least adjacent to the bottom wall;
d. introducing product and liquid into said trough at said inlet end to a level approximating the depth of said paddles when they are in contact with the trough bottom;
e. maintaining the product and liquid in discrete batches separated only by the thickness of the paddles as the batches move in a relatively continuous non-agitated flow along said trough;
f. operating the continuous conveyor at a predetermined speed in relation to the length of the trough between the inlet end and the liquid extraction section whereby to provide a predetermined residence time of the product in said liquid prior to its extraction;
g. providing said liquid extraction section in the form of a drain screen having an upper surface coplanar with said trough bottom wall, and gravitationally extracting liquid from each batch of product during passage of the batch over said screen; and
h. discharging product from the outlet end after completion of the extraction.

2. The method according to claim 1 including the step of maintaining a downward restraint against said paddles toward the trough bottom at least between the inlet end and extraction section in order to maintain the paddles edges is said intimate contact, said contact damming and essentially sealing each product and liquid batch against liquid flow between adjacent batches.

3. The method according to claim 1 wherein said liquid comprises water and wherein said method further includes the step of recirculating the liquid from said extraction section to said inlet end.

4. The method according to claim 3 wherein said particulate product comprises a vegetable or fruit that has been reduced in size to less than whole.

5. The method according to claim 4 wherein said liquid further includes calcium chloride and wherein said product is diced tomatoes.

6. The method according to claim 4 wherein said product is cut baby carrots.

7. The method of continuously conveying discrete batches of a particulate product immersed in a treating liquid for a predetermined time period and extracting the liquid from the product during the conveyance, comprising the steps of:
a. providing an elongated horizontal stationary watertight trough having a product and liquid inlet end, a product discharge end remote from the inlet end and a liquid extraction section intermediate said inlet and discharge ends, said trough having a bottom wall and opposing upwardly and outwardly-extending side walls for the length thereof;
b. segregating said discrete batches from one another with spaced-apart relatively thin flat product-conveying paddles having sides in contact with said product and liquid and having edges in relatively intimate contact with said bottom and side walls;
c. introducing product and liquid into said trough at said inlet end to a level approximating the depth of said paddles when they are in contact with the trough bottom;
d. driving said paddles at a predetermined uniform speed in relation to the length of the trough between the inlet end and the liquid extraction section whereby to provide a predetermined residence time of the product in said liquid prior to its extraction;
e. gravitationally extracting liquid from each batch of product during passage of the batch over said extraction section; and
f. discharging product from the outlet end after completion of the extraction.

8. The method according to claim 7 including the step of maintaining a downward restraint against said paddles toward the trough bottom at least between the inlet end and extraction section in order to maintain the paddles edges is said intimate contact, said contact damming and essentially sealing each product and liquid batch against liquid flow between adjacent batches.

9. The method according to claim 7 wherein said liquid comprises water and wherein said method further includes the step of recirculating extracted liquid from said extraction section to said inlet end.

10. The method according to claim 9 wherein said liquid further includes calcium chloride and wherein said product is diced tomatoes.

11. In a drag conveyor for en masse moving of particulate product and liquid in continuous discrete batches and extracting the liquid from the product during movement:
a. said conveyor comprising an elongated horizontal watertight trough having an inlet end for introducing product and liquid thereinto, a product discharge end and a liquid extraction section situated intermediate said ends;
b. said trough further having an inner end wall adjacent said inlet end, an inner bottom wall and a pair of opposing upwardly and outwardly-extending inner side walls;
c. said liquid extraction section comprising a horizontal drain screen mounted in said bottom wall with the upper surface thereof in coplanar alignment with said bottom wall and further having drain openings therethrough;
d. a continuous chain mounted for travel in a vertical plane within and above the trough from said inlet end to a location beyond said discharge end, said chain being supported on a horizontal axis drive sprocket adjacent the discharge end and a horizontal axis driven sprocket adjacent the inlet end;
e. a plurality of relatively thin, flat radially-outward extending product-conveying paddles carried by and spaced along said chain, all of said paddles being of the same lateral shape and dimensions with the radially-outward and side edges thereof being the same size and configuration as said inner trough bottom wall and side walls whereby to maintain relatively intimate contact with the bottom wall and at least a portion of each side wall extending upwardly from the bottom wall;
f. a motor for driving said drive sprocket and chain with a lower run of said paddle edges contacting the bottom and side walls as the chain moves them through the trough, whereby liquid and product entering the inlet end are substantially maintained as discrete product batches between retention dams formed by adjacent paddles;
g. a fixed-position elongated holddown surface adjacent each inner side wall and extending the length of said trough, said holddown surfaces being positioned to be contacted by radially-inner edges of said paddles as they traverse the trough in order to maintain the outer edges of said paddles in intimate contact with said bottom wall; and
h. the drain openings in said drain screen and the speed of the motor and chain being so interrelated as to provide sufficient time to drain liquid from the product during passage of the product over the liquid extraction section.

12. In a drag conveyor according to claim 11, liquid-conducting conduit extending between said liquid extraction section and said inlet end for enabling recirculation of extracted liquid to be redirected to said inlet end for reuse.

13. In a drag conveyor according to claim 11, a cover extending over the trough for its full length, and a plurality of pressurized spray wash elements within the trough and spaced at various locations therealong whereby, upon completion of conveying a given product, the drag conveyor may be continued in operation for a period of time sufficient to enable complete cleaning of the entirety of the trough, chain and paddles by means of the spray and the self-cleaning contact of the bottom of the trough by said paddle edges.
